(19) United States
(12) Patent Application Publication
(10) Pub. No.: US 2022/0187118 A1
(43) Pub. Date: Jun. 16, 2022

(54) Angle Detection Device

(71) Applicant: VITESCO TECHNOLOGIES GMBH, Taufkirchen (DE)

(72) Inventor: Werner WALLRAFEN, Munich (DE)

(21) Appl. No.: 17/439,887

(22) PCT Filed: Mar. 19, 2020
(86) PCT No.: PCT/EP2020/057672

§ 371 Date: Sep. 16, 2021

(30) Foreign Application Priority Data
Mar. 20, 2019 (DE) 10 2019 203 825.5
Mar. 20, 2019 (DE) 10 2019 203 827.1

(51) Int. Cl. G01F 23/38

(52) U.S. Cl. CPC G01F 23/38

(57) ABSTRACT

An angle detection device, in particular for a fuel filling level detection device includes: a carrier; a cover, which has been connected to the carrier by at least one solder or adhesive connection layer; and a sensor for the contactless detection of an orientation of a magnetic field of a magnet. The sensor has been arranged in an interior space, which has been defined by the carrier and the cover, in particular on the carrier.

### CROSS REFERENCE TO RELATED APPLICATIONS

This is a U.S. national stage of Application No. PCT/EP2020/057672 filed Mar. 19, 2020. Priority is claimed on German Application Nos. DE 10 2019 203 825.5 and DE 10 2019 203 827.1 filed Mar. 20, 2019 the content of which is incorporated herein by reference.

### BACKGROUND OF THE INVENTION

### 1. Field of the Invention

The present disclosure relates to an angle detection device, an angle detection arrangement, and a fuel filling level detection device with the angle detection device as well as a method for detecting an angle by the angle detection device, in particular arrangement, for detecting a fuel filling level by the fuel filling level detection device, and for producing the angle detection device.

### 2. Description of the Related Art

DE 196 48 539 C2 discloses a passive magnetic position sensor with a contact structure that can be deflected under the effect of a magnetic device.

### SUMMARY OF THE INVENTION

One aspect of the present invention is to provide a novel angle detection device or arrangement, in particular a fuel filling level detection device, and/or to improve its production, and/or function.

One aspect of the invention is an angle detection device. One aspect of the invention is an angle detection arrangement or a fuel filling level detection device with an angle detection device described here or to a method for detecting an angle by an angle detection device, in particular arrangement, described here, in particular for detecting a fuel filling level by a fuel filling level detection device described here, or for producing an angle detection device described here.

According to one aspect of the present invention, an angle detection device has a carrier, a cover that has been or is connected to the carrier by one or more, in one embodiment ring-like, solder connection layers or one or more, in one embodiment ring-like, adhesive connection layers, and a sensor which contactlessly detects an orientation of a magnetic field of a magnet or has been provided, in particular set up, or is used for this purpose.

In one embodiment, the sensor is a Hall (effect) sensor, in particular a 2D vertical Hall sensor or 2D lateral Hall sensor, in particular a differential or triaxial sensor, an xMR sensor, in particular an AMR, GMR, or TMR sensor, a magnetic saturation sensor or the like.

By a contactlessly sensing sensor, in one embodiment wear can be reduced, in particular in comparison with the contact structure known from DE 196 48 539 C2, and thus in one embodiment reliability, precision and/or service life can be improved.

According to one aspect of the present invention, the sensor has been or is arranged in an interior space which has been completely or partially defined by the carrier and the cover connected to it, in one embodiment on the carrier, in one development within the ring-like solder or adhesive connection layer, in one embodiment in a material-bonding manner, in one development by soldering and/or bare chip assembly (“chip-on-board” technology, COB).

As a result, according to on aspect the sensor can be advantageously protected from environmental influences. The solder or adhesive connection layer(s) has or have the effect that in one embodiment the carrier and cover have been or are connected to one another in a sealed manner, in one embodiment in an air-tight and/or liquid-tight manner, in particular with respect to water, gasoline and/or diesel, whereby the sensor can be (more) advantageously protected from environmental influences.

In particular, for this purpose in one aspect of the invention, the solder or adhesive connection layer is (in each case) resistant to fuel, in particular gasoline and/or diesel. The or at least one of the solder connection layer(s) comprise(s) in one aspect of the invention, in particular for this purpose, a metal, in particular tin and/or silver, alloy, and/or glass, in particular glass solder; it can in particular consist of this.

In one aspect of the invention, an outer edge of the or at least one of the solder or adhesive connection layer(s) has been or is arranged at least 1 mm and at most 15 mm, in particular at most 10 mm, away from an outer edge of the carrier.

As a result, in one aspect of the invention the tightness and/or production of the angle detection device can be improved, in particular in comparison with edge soldering and in particular edge welding. In one embodiment, this advantageously allows step and repeat panel production, in which an (overall) carrier plate is first loaded with multiple sensors and covers and then divided into carriers for the individual angle sensors.

In one aspect of the invention, the angle detection device has one or more, preferably two or three, conductor tracks, which have been or are (in each case) arranged, in one embodiment in a material-bonding manner, against, in particular on and/or in, the carrier and in one embodiment have been provided, in particular set up, or are used for electrical signal transmission or as electrical conductor tracks. The carrier can thus in particular have, in particular be, a substrate, against, in particular on, which the conductor track(s) has/have been or is/are arranged, in one embodiment can be formed together with the conductor track(s) as a circuit carrier or printed circuit board.

As a result, the angle detection device can in one embodiment be formed (more) compactly and/or (more) reliably and/or be produced (more) easily.

In one aspect of the invention, the sensor has been or is arranged, in particular in a material-bonding manner, at least partially on the or one or more of the conductor track(s) or in one embodiment at least partially covers them (in each case). In this way, according to one aspect its, in particular material-bonding, fastening can be improved.

In one aspect of the invention, the or one or more of the conductor track(s) has/have been or is/are (in each case) arranged entirely or completely or (only) partially in the interior space.

In one development, the or one or more of the conductor track(s) has/have been or is/are led out of the interior space between the carrier and the cover, in one embodiment by an electrical insulation and/or adhesive connection layer between the carrier and the cover, wherein this electrical insulation or adhesive connection layer in one aspect covers the conductor track(s) at least locally.

As a result, in one aspect of the invention the tightness and/or production of the angle detection device can be (further) improved; in one aspect of the invention, through-openings in the interior space that extend through the carrier, which impair the (permanent) tightness of the interior space and/or have to be (more) laboriously produced and/or sealed off, can be avoided.

Additionally or alternatively, the or one or more of the conductor track(s) has/have been or is/are (in each case) connected to an electrical feedthrough, in one embodiment a vertical interconnect access (“via”), which extends entirely or completely or (only) partially through the carrier or the cover and in one aspect of the invention has been or is connected to a further conductor track, which in one embodiment has been or is arranged, in particular in a material-bonding manner, on a surface of the carrier facing away from the cover.

In one aspect of the invention, the or one or more of the feedthrough(s) or via(s) has/have (in each case) a through-passage in the carrier or the cover that extends through the latter, wherein the through-passage has been filled in an electrically conducting manner or its (inner) wall has been coated in an electrically conducting manner, so that the conductor track connected to it, arranged at least partially in the interior space, can in one aspect of the invention be electrically supplied and/or tapped from a side of the carrier facing away from the cover by way of the feedthrough or via.

In one aspect of the invention, the or one or more of the feedthrough(s) or via(s) has/have been (in each case) closed or sealed in an air-tight and/or liquid-tight manner, in particular with respect to water, gasoline and/or diesel, in one aspect of the invention in a material-bonding manner, in particular by soldering, in one embodiment metallic or glass soldering, or adhesive bonding.

In one aspect of the invention, one end of the or one or more of the feedthrough(s) has/have been (in each case) arranged in the interior space. In one aspect of the invention, both ends of the or one or more of the feedthrough(s) has/have been (in each case) arranged outside the interior space.

As a result, in one aspect of the invention, in particular in combination of two or more of these features, the signal transmission from the interior space can in each case be implemented (more) easily, (more) compactly, and/or (more) reliably.

In one aspect of the invention, the or one or more of the conductor track(s), which have been arranged entirely or completely in the interior space, have been or are (in each case) therefore connected to one (of the) feedthrough(s), one end of which has likewise been arranged in the interior space, in particular with this end, wherein in one aspect of the invention the other end of this feedthrough can have been or can be connected to a further conductor track on a surface of the carrier facing away from the cover.

Additionally or alternatively, in one aspect of the invention the or one or more of the conductor track(s), which have been led out of the interior space between the carrier and cover, have been or are (in each case) connected to one (of the) feedthrough(s), both ends of which have been arranged outside the interior space, in particular with one of these ends, wherein in one aspect the other end of this feedthrough can have been or can be connected to a further conductor track on a surface of the carrier facing away from the cover.

In one aspect of the invention, the or one or more of the conductor track(s), in particular therefore the or one or more of the conductor track(s) that have been led out of the interior space between the carrier and the cover, or the or one or more of the conductor track(s), in particular arranged entirely in the interior space, which have been connected to one (of the) electrical feedthrough(s) that extend(s) through the carrier or the cover, have been or are (in each case) connected, in one aspect of the invention by way of at least one further conductor track, to an (electrical) terminal, which in one embodiment has been arranged on a side of the carrier facing toward the cover, in another aspect of the invention on a side of the carrier facing away from the cover. In one aspect of the invention, a line can have been or can be fastened to the terminal, in a material-bonding manner, in particular by soldering, or in a frictionally engaging manner, in particular by a clamp.

In one aspect of the invention a terminal on the cover side allows the angle detection device to be formed (more) compactly, in one aspect of the invention a terminal facing away from the cover allows the surface of the carrier facing away from the cover to be better used or also used.

In one aspect of the invention, the angle detection device has an evaluation circuit which has been or is arranged in the interior space, in particular, in one embodiment in a material-bonding manner, on the carrier, in one embodiment by a bare chip assembly (COB), and/or evaluates, in particular processes, signals from the sensor, or has been provided, in particular set up, or is used for this purpose.

As a result, in one aspect of the invention the evaluation or processing of signals from the sensor can be implemented at least partially by the angle detection device itself, and thus in one aspect of the invention the connection and/or the use of the angle detection device can be improved.

In one development, the evaluation circuit has been programmed, in one aspect of the invention by way of the or one or more of the conductor track(s), or the evaluation circuit and possibly conductor track(s) have been provided, in particular set up, or are used for this purpose. In particular, a characteristic curve for the sensor, which in one aspect of the invention is variable, can be or can have been stored in the evaluation circuit and/or specified, in particular changed, by way of the or one or more of the conductor track(s).

As a result, in one aspect of the invention the angle detection device can be advantageously adjusted for the first time or re-adjusted in situ.

Additionally or alternatively, in one aspect of the invention the evaluation circuit is formed as a bare chip (“bare die”).

As a result, in one aspect of the invention production can be (further) improved and/or the angle detection device can be formed (more) compactly.

Additionally or alternatively, in one aspect of the invention the evaluation circuit has been formed as an integrated circuit with the sensor or combined with the sensor to form an integrated circuit.

As a result, in one aspect of the invention production can be (further) improved and/or the angle detection device can be formed (more) compactly.

In an alternative aspect of the invention, the evaluation circuit has been formed separately from the sensor, in particular the evaluation circuit and the sensor have been arranged individually and/or at a distance from one another, in one embodiment on the carrier.

As a result, in one aspect of the invention the production of different angle detection devices can be made easier.

In one aspect of the invention, the angle detection device has one or more electrical components, in particular capacitor(s) or the like, which have been or are arranged in the interior space, in one embodiment on the carrier and/or in a material-bonding manner, and have been or are electrically connected to the sensor and/or the evaluation circuit, in particular by way of the or one or more of the conductor track(s).

As a result, in one aspect of the invention signal filtering and/or protection, in particular electrical protection, in particular interference-voltage or overload protection, can be advantageously implemented.

In one aspect of the invention, the sensor, the evaluation circuit and/or the or one or more of the electrical components have been or are (in each case) connected to the or one or more of the conductor track(s), in one embodiment by contacts and/or lines, in particular bonding wires or the like.

In one aspect of the invention, the sensor, the evaluation circuit and/or the or one or more of the electrical components are electrically supplied and/or tapped by way of the or one or more of the conductor track(s) and/or signals, in particular electrical signals, are transmitted from the sensor, the evaluation circuit and/or the or one or more of the electrical components and/or signals, in particular electrical signals, are transmitted to the sensor, the evaluation circuit and/or the or one or more of the electrical components by way of the or one or more of the conductor track(s) or the conductor track(s) is/are used for this purpose or this/these conductor track(s) has/have been provided, in particular set up, for this purpose.

As a result, in one aspect of the invention the production and/or electrical connection can be (further) improved.

In one aspect of the invention, the carrier has one or more electrically insulating surface areas, in one development a single- or multi-layer base body or a single- or multi-layer substrate of electrically insulating material.

As a result, in one aspect of the invention the conductor tracks can be advantageously implemented or electrically insulated from one another.

In one aspect of the invention, the cover comprises metal and/or a non-ferromagnetic material, such as for example ceramic, plastic or the like; it can in particular consist completely of metal or, in an alternative embodiment, be coated with metal on an edge of a base body connected to the connection layer, which in one aspect of the invention consists of non-ferromagnetic material.

Metal covers or covers with metallized edges can in one embodiment be soldered particularly advantageously. In the case of covers which consist at least partially of non-ferromagnetic material, the magnet detected by the sensor can advantageously have been or be arranged on the cover side.

In one aspect of the invention, the cover has a recess in which the sensor has been at least partially received. In particular, the cover can have been or can be formed like a pot.

As a result, in one aspect of the invention the sensor can be protected and/or the angle detection device can be formed (more) compactly.

In one aspect of the invention, the interior space has been or is completely or partially filled with gas and/or an elastic filler or evacuated.

In this way, in one aspect of the invention the sensor, the evaluation circuit and/or the electrical component(s) can be advantageously protected.

In one aspect of the invention, at least one, in one embodiment ring-like, electrical insulation has been or is arranged between the carrier and the cover, and in one aspect of the invention at least partially covers the or one or more of the conductor track(s) and/or has been or is arranged on the carrier or the cover in a material-bonding manner Additionally or alternatively, at least one, in one embodiment metallic and/or ring-like, fastening layer, on which the or at least one of the solder or adhesive connection layer(s) has been or is arranged, has been or is arranged between the carrier and the cover, in one aspect of the invention on the carrier or this electrical insulation and/or in a material-bonding manner In another aspect of the invention, the or at least one of the solder or adhesive connection layer(s) has been or is arranged on the electrical insulation or the carrier.

As a result of the electrical insulation, in one aspect of the invention the conductor tracks between the carrier and the, in particular soldered, cover can advantageously have been or be led out of the interior space and/or, in particular, electrically insulated from one another. In one aspect of the invention, the adhesive connection layer can at least partially form the electrical insulation. In one aspect of the invention, the formation of the solder connection layer can be improved by the fastening layer.

According to one aspect of the present invention, an angle detection arrangement has an angle detection device described here and a movable magnet, wherein in one embodiment an orientation of a magnetic field of this magnet is contactlessly detected or can be detected by the sensor.

In one aspect of the invention, the carrier has been or is arranged between the cover and the magnet, or the magnet has been or is arranged on the side of the carrier facing away from the cover.

As a result, in one aspect of the invention the cover can have been produced from metal with ferromagnetic properties.

In an alternative aspect of the invention, the cover has been or is arranged between the carrier and the magnet, or the magnet has been or is arranged on the side of the cover facing away from the carrier.

In this way, in one aspect of the invention a vertical interconnect access through the carrier can be implemented particularly advantageously. Additionally or alternatively, as a result a distance between the magnet and the sensor can be reduced, in particular in the case of a non-ferromagnetic cover.

In one aspect of the invention, the magnet is rotatable or has been mounted rotatably about an, in particular kinematic, axis of rotation that intersects the interior space, in particular virtually, and/or includes with a vertical axis of the carrier that runs in the direction of its, in particular minimal, wall thickness an angle which is at most 45°, in particular at most 30°, in one embodiment at most 15°, in particular therefore at least substantially perpendicular to the carrier or its plane.

As a result, in one aspect of the invention the angle detection arrangement can be formed (more) compactly and/or can detect (more) precisely the orientation or angular position of the magnet.

An angle detection device or arrangement according to the invention can be used or have been provided, in particular set up, with particular advantage for detecting a fuel filling level, in particular on the basis of advantageous tightness and/or angle detection.

Correspondingly, according to one aspect of the invention of the present invention a fuel filling (level) detection device, in particular for a motor vehicle, in one aspect of the invention of a motor vehicle, has an angle detection device described here and a magnet, the magnetic field orientation of which is contactlessly detected or can be detected by the sensor of the angle detection device, or an angle detection arrangement described here.

In one aspect of the invention, a float is coupled to this magnet or the magnet of this angle detection arrangement of the fuel filling (level) detection device, in one embodiment mechanically, in particular by way of a linkage or the like, and/or in such a way that a change in the filling level leads to a, in particular defined, rotation of the magnet about an or the axis of rotation or a corresponding change in an orientation of its magnetic field, which can be or is detected by the sensor.

According to one aspect of the present invention, to detect an angle by an angle detection device, in particular arrangement, described here, in one embodiment for detecting a fuel filling level by a fuel filling (level) detection device described here an orientation of a magnetic field of a or the magnet is contactlessly detected by the sensor and a corresponding signal, which in one aspect has been processed by the evaluation circuit and/or on the basis of a characteristic curve stored in the angle detection device, in particular evaluation circuit, and in one aspect has been specified, in particular changed, by way of the or one or more of the conductor track(s), is output, in one aspect by way of the or one or more of the conductor track(s).

According to one aspect of the present invention, to produce an angle detection device described here, the cover and the carrier are connected to one another by the solder or adhesive connection layer(s), in one embodiment by reflow soldering of at least one solder layer.

Additionally or alternatively, according to one aspect of the present invention, to produce multiple angle detection devices described here, in one aspect of the same construction, an, in particular one-piece, carrier plate is first loaded with multiple sensors, in one embodiment additionally with multiple evaluation circuits and/or electrical components, and is then divided into carriers for the individual angle sensors.

In one aspect of the invention, after loading the carrier plate with the sensors, and possibly evaluation circuits and/or electrical components, multiple covers are connected to the carrier plate, in one embodiment still in one piece, by the respective solder or adhesive connection layer(s), in one aspect by reflow soldering, so that in each case one of the sensors, and if applicable one of the evaluation circuits and/or one or more of the electrical components, has or have been arranged in an interior space that has been defined by the carrier plate and the respective cover, and then the carrier plate loaded in this way is divided or individually separated into (carriers for the or of the) individual angle detection device(s). In particular, the carrier plates can therefore be a panel or the angle detection devices can be produced by step and repeat panel production.

In one aspect of the invention, the sensor, the evaluation circuit and/or the electrical component(s) of the or one or more angle detection device(s) are or have been electrically connected (in each case) to the or one or more of the conductor track(s), in one aspect in a material-bonding manner, by way of contacts and/or by wires, in particular bonding wires, in one embodiment during or after the loading of the carrier plate with the sensors, evaluation circuits or electrical components and before the connection to the covers.

In one aspect of the invention, the carrier with the conductor track(s) is (formed as) a printed circuit board or a circuit carrier or the carrier plate is (formed as) an entire printed circuit board.

Additionally or alternatively, in one embodiment the carrier comprises ceramic, glass, plastic and/or epoxy resin material, in particular ceramic, glass, plastic and/or epoxy resin laminate and/or composite material, in one embodiment plastic and/or epoxy resin material, in particular polyimide, polytetrafluoroethylene or hydrocarbon resin, in particular with glass fibers and/or ceramic, in particular ceramic filler, in particular can have been or can be produced from this, in particular therefore from ceramic material, epoxy glass-fiber composite material, hydrocarbon resin with ceramic filler, polytetrafluoroethylene composite material with ceramic or polyimide composite material with glass fibers.

As a result, in one aspect of the invention, in particular in combination of two or more of the aforementioned features, the production and/or tightness, in particular service life, of the angle or fuel filling level detection device can in each case be (further) improved and/or made easier.

In one aspect of the invention, the cover has been arranged over the carrier. Additionally or alternatively, in one aspect of the invention the carrier completely covers the cover. Additionally or alternatively, the or one or more of the conductor track(s) is/are arranged flat against, in particular on or in, the carrier.

As a result, in one aspect of the invention, in particular in combination of two or more of these features, the angle detection device can in each case be produced advantageously, in particular easily and/or compactly.

### BRIEF DESCRIPTION OF THE FIGURES

The invention is explained in detail in the following text with reference to the representations in the figures. Further advantageous developments of the invention are apparent from the dependent claims and the description below of preferred embodiments. In this respect, in the partially schematic figures:

FIG. 1 is a fuel filling level detection device with an angle detection arrangement with an angle detection device;

FIG. 2 is the angle detection arrangement in a plan view;

FIG. 3 is the angle detection arrangement in a section along the line III-III in FIG. 2;

FIG. 4 is an angle detection arrangement corresponding to FIG. 3; and

FIG. 5 is a plan view of a carrier plate during the production of the angle detection device.

### DETAILED DESCRIPTION OF THE PRESENTLY PREFERRED EMBODIMENTS

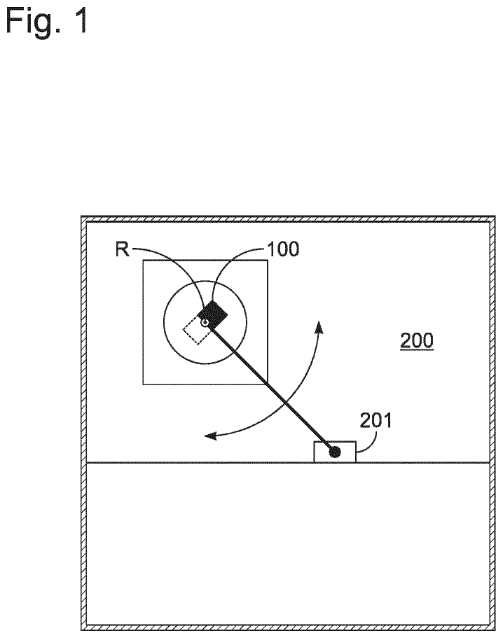

FIG. 1 shows a fuel filling level detection device with an angle detection arrangement arranged in a fuel tank 200, with an angle detection device according to one aspect of the present invention.

A float 201 is coupled to a permanent magnet 100 of the detection device in such a way that a change in the filling level leads to a rotation of the magnet 100 about an axis of rotation R, which is perpendicular to the plane of the drawing in FIG. 1.

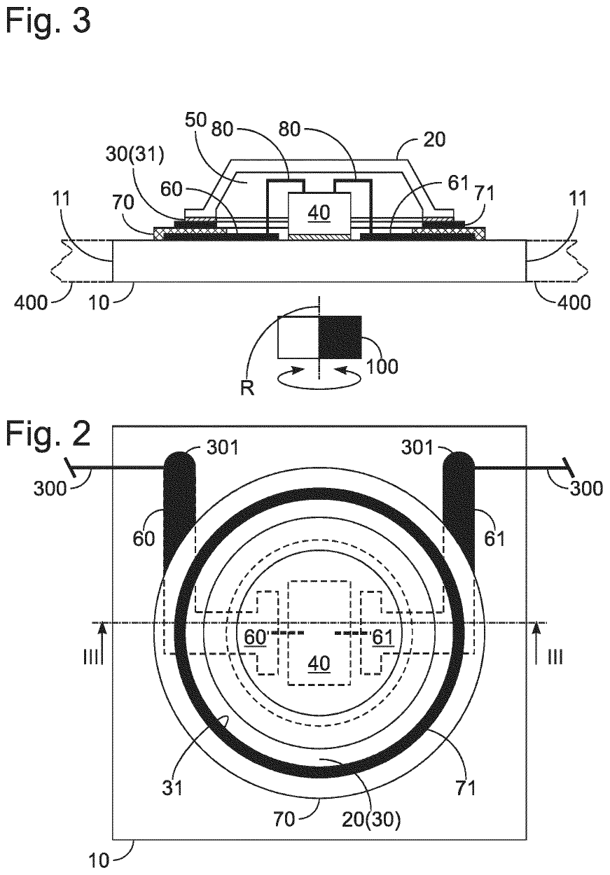

FIG. 2 shows the angle detection arrangement in a plan view, FIG. 3 in a section along the line III-III in FIG. 2.

The angle detection device of this angle detection arrangement has a carrier 10 and a cover 20.

On a surface of the carrier 10 (at the top in FIG. 3), two conductor tracks 60, 61 and a ring-like electrical insulation 70, which covers the two conductor tracks 60, 61, have been arranged in a material-bonding manner.

A metallic fastening layer 71, to which the cover 20 has been connected by a solder connection layer 30, has been arranged in a material-bonding manner on the electrical insulation 70, so that the carrier 10 and the cover 20 define an interior space 50. An outer edge 31 of this solder connection layer 30 is between 1 mm and 15 mm away from an outer edge 11 of the carrier 10.

A sensor for the contactless detection of an orientation of a magnetic field of the magnet 100 has been arranged within the interior space 50, and in the exemplary embodiment of FIGS. 2 and 3 has been combined with an evaluation circuit to form an integrated circuit 40, which has been arranged in a material-bonding manner on the carrier 10 and connected by way of bonding wires 80 to the conductor tracks 60, 61, which for their part have been led out of the interior space 50 between the carrier 10 and the cover 20 and by way of which signals from the integrated circuit 40 can be output to lines 300, which are connected in a material-bonding or frictionally engaging manner to the conductor tracks 60, 61 at terminals 301, and by way of which on the other hand, conversely, a characteristic curve of the evaluation circuit of the integrated circuit 40 for evaluating the sensor can be programmed, in particular reprogrammed, in situ.

In the exemplary aspect of the invention of FIGS. 2 and 3, the carrier 10 has been arranged between the cover 20 and the magnet 100, the axis of rotation R of which intersects the interior space 50 and includes an angle of approximately 0° with a vertical axis of the carrier in the direction of its wall thickness (vertically in FIG. 3).

To detect the filling level, the orientation of the magnetic field of the magnet 100 is contactlessly detected by the sensor of the integrated circuit 40 and a corresponding signal processed by the evaluation circuit of the integrated circuit 40 on the basis of a characteristic curve stored or programmed in it is output to the lines 300 by way of the conductor tracks 60, 61.

To produce multiple structurally identical angle detection devices explained above, a carrier plate 400, indicated by dashed lines in FIG. 3, on the surface of which the respective conductor tracks 60, 61 have been arranged, is first loaded with multiple of the integrated circuits 40, before, at the same time as or after which the respective electrical insulations 70 have been or are arranged, and on them the metallic fastening layers 71, these are then in each case connected to a cover 20 by reflow soldering of a solder layer, which forms the respective solder connection layer 30, and then the carrier plate 400 loaded in this way is divided into (carriers 10 for the or of the) individual angle detection device(s).

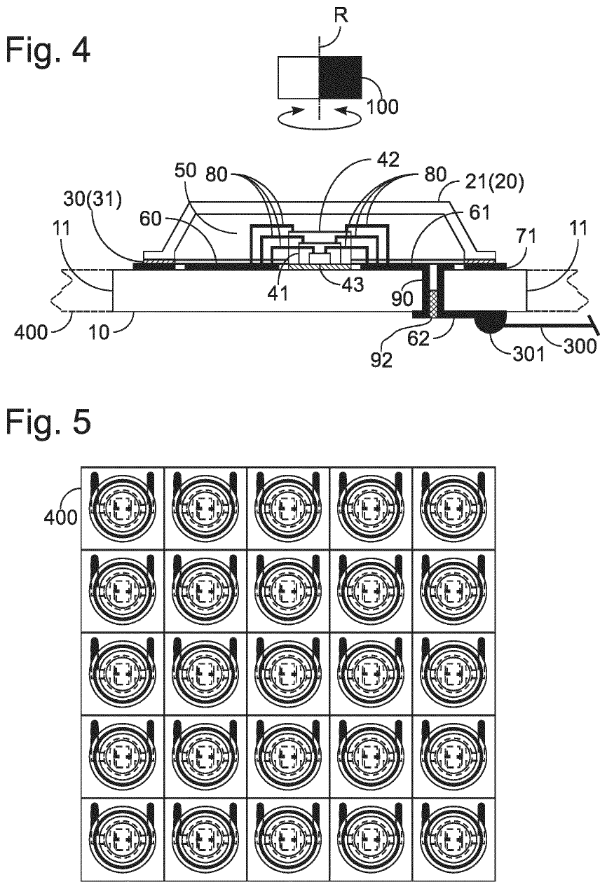

FIG. 4 shows, in a representation corresponding to FIG. 3, an angle detection arrangement according to a further embodiment of the present invention, which can be used instead of the angle detection arrangement of FIGS. 2 and 3 in the fuel filling level detection device of FIG. 1.

Features that are the same or have the same effect are identified by the same reference signs, so that reference is made to the above description and only differences are discussed below.

In the exemplary embodiment of FIG. 4, the conductor tracks 60, 61 have not been led out of the interior space 50 between the carrier 10 and the cover 20, but have been connected to vertical interconnect accesses 90, which reach through the carrier 10 and for their part have been connected to conductor tracks 62, which have been arranged on the surface of the carrier 10 facing away from the cover (at the bottom in FIG. 4). The vertical interconnect accesses 90 are sealed with a filler 92.

In addition, in the exemplary aspect of the invention of FIG. 4 the sensor 41 for the contactless detection of the orientation of the magnetic field of the magnet 100, the evaluation circuit in the form of a bare chip 42 and a capacitor 43 have been formed separately, in each case arranged in a material-bonding manner on the carrier 10 and connected to the conductor tracks 60, 61 by bonding wires 80.

In addition, in the exemplary aspect of FIG. 4 the cover 20 has been arranged between the carrier 10 and the magnet 100 and connected without electrical insulation 70 to the carrier 10 by the solder connection layer 30.

For this purpose, the cover 20 has a base body 21 of non-ferromagnetic material, the edge of which has been or is metallized and has been or is connected to the solder connection layer 30 by reflow soldering during the step and repeat panel production explained above. The metallic fastening layer 71 has been arranged on the carrier 10 in a material-bonding manner

FIG. 5 shows a plan view of the carrier plate 400 during the production of the angle detection device(s).

Although exemplary embodiments have been explained in the above description, it should be noted that numerous modifications are possible.

In particular, instead of the two conductor tracks shown, three or more conductor tracks can also have been provided.

Additionally or alternatively, features that have been explained with reference to the exemplary aspect of FIG. 4 can also be implemented in the exemplary aspect of FIGS. 2 and 3 and vice versa, in particular therefore the metallic cover 20, the integrated circuit 40 and/or the carrier-side arrangement of the magnet 100 in the exemplary embodiment of FIG. 4 and/or the separate arrangement of the sensor 41, evaluation circuit 42 and/or capacitor 43, the non-ferromagnetic base body 21 and/or the cover-side arrangement of the magnet 100 in the exemplary aspects of FIGS. 2 and 3.

Additionally or alternatively, instead of the solder connection layer 30, an adhesive connection layer can have been or can be provided in each case. In this case, the fastening layer or metallization of the cover edge can be omitted and/or the adhesive connection layer at the same time can form an electrical insulation, in particular in the exemplary embodiment of FIGS. 2 and 3 with the conductor tracks 60, 61 led out of the interior space between the carrier and the cover.

Additionally or alternatively, the sensor 40 or 41 can have been or can be partially arranged on the two conductor tracks 60, 61 or one of these two conductor tracks 60, 61, in one embodiment in a material-bonding manner, or in one embodiment partially cover them (in each case).

Furthermore, it should be noted that the exemplary embodiments are merely examples, which are not intended to limit the scope of protection, the applications and the construction in any way. Rather, the above description gives a person skilled in the art a guideline for the implementation of at least one exemplary embodiment, wherein various changes may be made, especially with regard to the function and arrangement of the component parts described, without departing from the scope of protection resulting from the claims and combinations of features equivalent thereto.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1.-12. (canceled)

13. An angle detection device for a fuel filling level detection device, comprising:
a carrier;
a cover, connected to the carrier by at least one of a solder connection layer or an adhesive connection layer; and
a sensor for contactless detection of an orientation of a magnetic field of a magnet,
wherein the sensor is arranged on the carrier in an interior space defined by the carrier and the cover.

14. The angle detection device as claimed in claim 13, wherein an outer edge of the adhesive connection layer is at least 1 mm and at most 15 mm away from an outer edge of the carrier.

15. The angle detection device as claimed in claim 13, further comprising:
at least one conductor track arranged on the carrier.

16. The angle detection device as claimed in claim 15,
wherein a respective conductor track is arranged at least one of entirely in the interior space of the carrier or partially in the interior space of the carrier, and/or
an electrical feedthrough configured as a vertical interconnect access, which at least partially extends through the carrier or cover, and/or
at least one further conductor track connected to a terminal arranged on a side of the carrier facing toward the cover or facing away from the cover.

17. The angle detection device as claimed in claim 15, further comprising:
an evaluation circuit arranged in the interior space on the carrier and programmable by way of the at least one conductor track, the evaluation circuit configured to evaluate the sensor,
wherein the evaluation circuit has been formed as a bare chip and/or as an integrated circuit with the sensor, or has been formed separately from the sensor.

18. The angle detection device as claimed in claim 17, further comprising:
at least one electrical component, configured as a capacitor arranged in the interior space on the carrier and electrically connected to the sensor and/or the evaluation circuit by the at least one conductor track.

19. The angle detection device as claimed in claim 13,
wherein the carrier has:
at least one electrically insulating surface area and/or ceramic, glass, plastic and/or
epoxy resin material and/or
wherein the cover comprises:
metal and/or
a non-ferromagnetic material and/or
a recess in which the sensor has been at least partially received, and/or
the interior space has been at least partially filled with gas or an elastic filler or evacuated.

20. The angle detection device as claimed in claim 13,
wherein at least one electrical insulation is arranged between the carrier and the cover and/or
wherein at least one fastening layer, on which the adhesive connection layer has been arranged, has been arranged in particular on this electrical insulation or on the carrier.

21. An angle detection arrangement comprising:
an angle detection device, comprising:
a carrier;
a cover, connected to the carrier by at least one of a solder connection layer or an adhesive connection layer; and
a sensor for contactless detection of an orientation of a magnetic field of a magnet,
wherein the sensor is arranged on the carrier in an interior space defined by the carrier and the cover;
a movable magnet,
wherein the carrier is arranged between the cover and the magnet or the cover is arranged between the carrier and the magnet and/or the magnet has been mounted rotatably about an axis of rotation (R), which intersects the interior space and/or includes an angle with a vertical axis of the carrier in a direction of its wall thickness which is at most 45°.

22. A fuel filling level detection device for a motor vehicle, comprising:
an angle detection device, comprising:
a carrier;
a cover, connected to the carrier by at least one of a solder connection layer or an adhesive connection layer; and
a sensor for contactless detection of an orientation of a magnetic field of a magnet,
wherein the sensor is arranged on the carrier in an interior space defined by the carrier and the cover;
a magnet;
a float coupled to the magnet,
wherein an orientation of a magnetic field of the magnet can be contactlessly detected by the sensor; and
an angle detection arrangement.

23. A method for detecting an angle by an angle detection device, for a fuel filling level by a fuel filling level detection device including an angle detection device, comprising a carrier, a cover, connected to the carrier by at least one of a solder connection layer or an adhesive connection layer, and a sensor for contactless detection of an orientation of a magnetic field of a magnet, wherein the sensor is arranged on the carrier in an interior space defined by the carrier and the cover, a magnet, a float coupled to the magnet, comprising:
detecting an orientation of a magnetic field of the magnet contactlessly by the sensor;
processing a corresponding signal, by an evaluation circuit; and/or
outputting based on a characteristic curve stored in the angle detection device, by way of at least one conductor track.

24. A method for producing at least one angle detection device, comprising:
connecting a cover and a carrier to one another by a connection layer by reflow soldering of at least one solder layer, and/or
loading a carrier plate is loaded with multiple sensors and then divided into carriers for a plurality of angle detection devices.

25. The angle detection device as claimed in claim 15, wherein the at least one conductor track is arranged on the carrier in a material-bonding manner.

26. The angle detection device as claimed in claim 16,
wherein a respective conductor track is led out of the interior space between the carrier and the cover.
